(19) United States
(12) Patent Application Publication
(10) Pub. No.: US 2004/0061258 A1
(43) Pub. Date: Apr. 1, 2004

(54) Pipe coupling

(76) Inventor: David Mullan, Warwickshire (GB)

Correspondence Address: MYERS BIGEL SIBLEY & SAJOVEC, PO BOX 37428, RALEIGH, NC, 27627, US

(21) Appl. No.: 10/239,497

(22) PCT Filed: Mar. 21, 2001
(86) PCT No.: PCT/GB01/01231

(30) Foreign Application Priority Data
Mar. 21, 2000 (GB) 0006662.1
Mar. 30, 2000 (GB) 0007575.4
Mar. 1, 2001 (GB) 0105016.0

(51) Int. Cl. B29C 45/00; B29B 7/00

(52) U.S. Cl. 264/328.1; 264/214; 425/542

(57) ABSTRACT

The invention provides a method for making a pipe coupling which comprises a body portion including a socket (9) and an internal seal (43) located within said socket and which is for making sealing contact with the pipe end received in the socket. The method comprises, in a first stage, injection moulding the body portion using a first internal core and, in a second stage, injection moulding the seal within the socket using a second internal core. Seal material is injected in molten form through the wall of the body portion to a space defined by the body portion and said second core. Apparatus for carrying out the method is also provided.

### FIELD OF THE INVENTION

The invention relates to plastic pipe fitting provided with internal seals. The pipe fitting may be, for instance, a pipe (conduit), a pipe coupling which is straight or provides a bend of, for instance 90°, 135° or 180° or another tubular ended plastics arrangements such as a water trap. Reference will be made herein below to pipe coupling but it should be appreciated that the invention has application to any plastics arrangement which includes at least one tubular socket having an internal seal.

### BACKGROUND TO THE INVENTION

Pipe couplings may include at least one socket for receiving a pipe end, the socket having an internal seal for effecting sealing between the pipe coupling and the pipe end. Traditionally, the seal for such a pipe fitting is formed separately from the body of the coupling and the seal is then inserted into the socket sand held therein with some form of retention member which prevents the seal being displaced during the fitting of the pipe length into the socket of the coupling.

More recently, methods have been proposed by which the seal is formed integrally with the socket, thereby avoiding the need for a retaining member and for the items to be assembled together. In GB2192578A, a pipe coupling is made by injection moulding a socket in a mould tool having inner and outer cores and a third core defining an axially extending internal surface of the socket. Once the socket has been formed, the third core is moved axially in a direction towards the mouth of the socket to open up a space between the socket and the inner core into which seal material may be injected. The inner mould is then moved axially away from the socket and, in so doing, deforms the resilient seal. Core movement is effected while the mould tool is closed.

Such a method is effective for a socket in which the only hindrance to removal of the inner core is a sufficiently resiliently deformable seal. However where the seal is not sufficiently deformable in a resilient manner and/or where the inner surface of the socket includes hindering internal projections, for instance because the seal is located within a recessed spaced from the end of the socket, such a method is not satisfactory.

GB-A-1477074 discloses a two-stage method of moulding a pipe coupling having a tubular plastics member and an annular sealing member. The first member is injection moulded in a first moulding stage and the second member is then injection moulded onto the performed member in a second injection moulding stage. Both stages are preferably carried out in a common mould using different mould profiles respectively.

### STATEMENTS OF THE INVENTION

According to the present invention there is provided a method for making a pipe coupling comprising a body portion including a socket and an internal seal located within said socket and for making sealing contact with a pipe end received in the socket, said body portion and said seal being formed of plastics materials, the method comprising, in a first stage, injection moulding said body portion using a first internal core and, in a second stage, injection moulding said seal within said socket using a second internal core and by injecting material for the seal in molten form through the wall of said body portion to a space defined by said body portion and said second core, whereby, on solidifying, said second material adheres to said body portion, characterised in that said first and second internal cores each include first and second axially separable parts and said first part is provided with an external circumferential groove for accommodating an inwardly directed lip on the socket and, after each stage of injection moulding, said first part is moved axially relative to the second part causing the lip to move out of the groove thereby widening the mouth of the socket sufficiently to enable relatively unimpeded movement of said second part in a direction out of said socket.

The present invention also provides apparatus for making a pipe coupling comprising a body portion including a socket and an internal seal located within said socket for making sealing contact with a pipe end received in the socket, said body portion and said seal being formed of plastics materials, the apparatus comprising means for injection moulding said body portion using a first internal core and means for injection moulding the seal within said socket using a second internal core, said seal moulding means including means for injecting material for the seal in molten form through the wall of the body portion to a space defined by the body portion and said second core, whereby, on solidifying, said second material adheres to said body portion, characterised in that said first and second internal cores each include first and second axially separable parts and said first part is provided with an external circumferential groove for accommodating an inwardly directed lip on the socket, and means for moving said first part axially relative to the second part after each stage of injection moulding causing the lip to move out of the groove thereby widening the mouth of the socket sufficiently to enable relatively unimpeded movement of said second part in a direction out of said socket.

### DETAILED DESCRIPTION OF THE INVENTION

The present invention will now be described, by way of example only, with reference to the accompanying drawings.

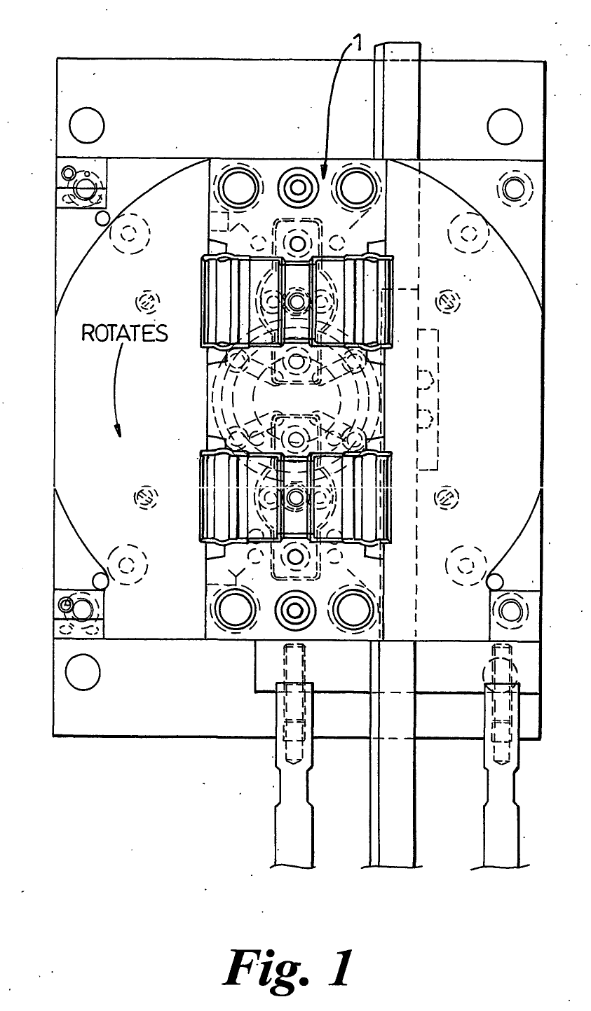

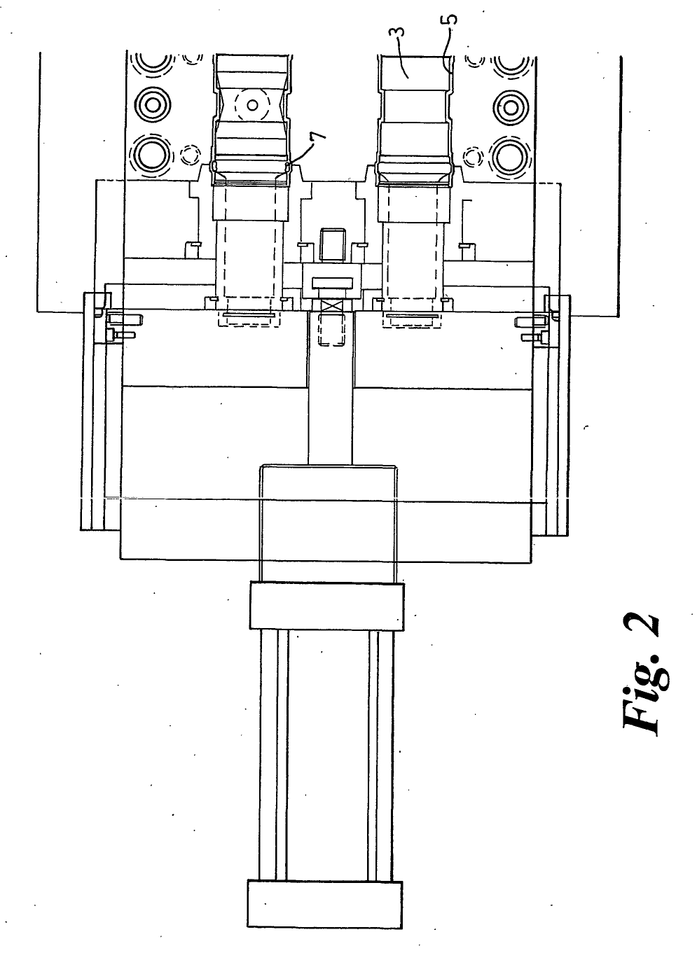

FIG. 1 of the accompanying drawings illustrates part of injection mould tooling which may be used in the method of the present invention. As illustrated in FIG. 1, this part of the tooling is substantially in the form of a core block 1 rotatable about a vertical axis. FIG. 2 illustrates the injection part of the moulding tool which allows the other components of the mould to be brought into alignment with those parts provided by the cavity block 1. The lower part of the tooling is shown in FIG. 2, the internal core arrangement 3 being such that, when brought into alignment with the cavity block 1, the body part 5 of a pipe coupling is formed. In the top half of FIG. 2 the core parts are such as to define a space into which the sealed material may be injected.

Accordingly a pipe coupling may be made, using tooling such as is illustrated in FIGS. 1 and 2, in a two-stage process involving a first stage injection moulding process, rotation of the cavity block 1 and a second stage procedure in which the internal seal is formed.

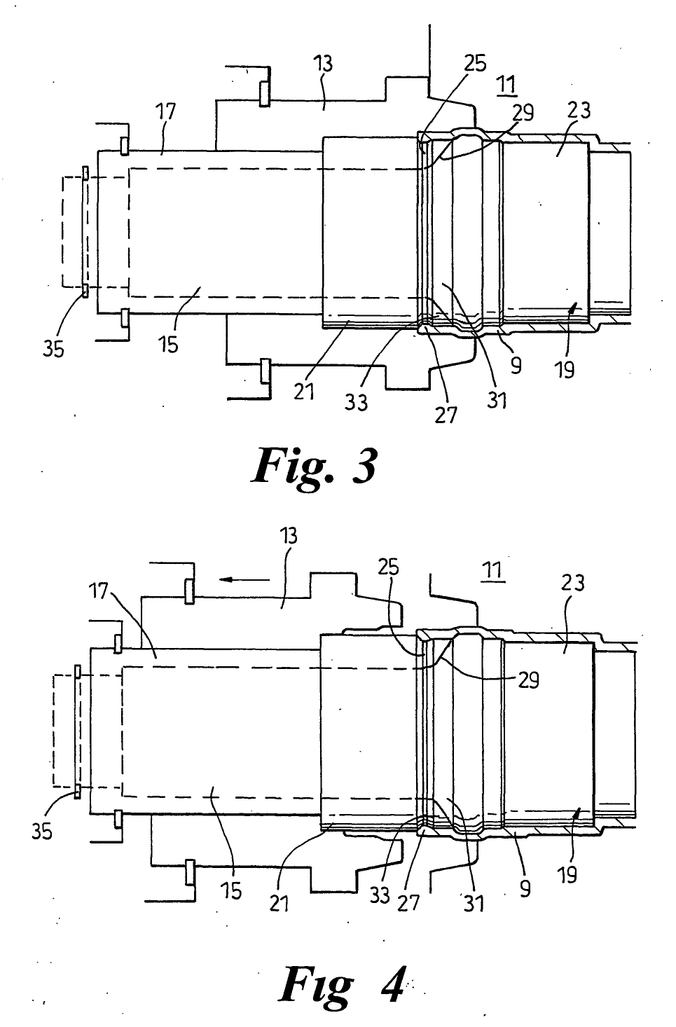

FIG. 3 of the accompanying drawings shows in detail the arrangement of the mould parts around one of the sockets 9 of the pipe coupling. The mould parts included outer mould parts 11 and 13 and an inner core assembly 15. Assembly 15 includes outer and inner core parts 17 and 19 respectively. Each of these core parts has an enlarged head portion, 21 and 23 respectively. These head portions together define the inner surface of the mould. Head portion 21 of inner part 17 is provided with a circumferential groove 25 which defines an internal circumferential lip 27 formed as a result of the injection moulding of the body portion of the coupling. Head portion 23 of outer part 19 is located axially inwardly of head portion 21 and a surface 29 defines a neck portion 31, extending between head portion 23 and the remainder of inner part 15, is shaped so as to fit flush to a corresponding internal surface at the innermost end of head portion 21 of outer part 17.

Having formed the body portion of the coupling by injection moulding, including socket 9 illustrated in FIG. 3, outer mould part 13 is then caused to move axially away from the socket 9 to the position shown in FIG. 4.

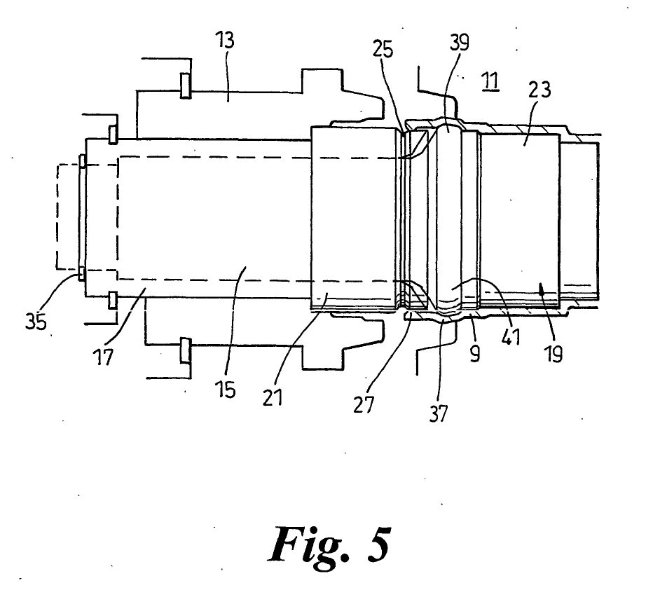

Outer part 17 of core assembly 15 is capable of axial movement away from inner core part 19 and socket 9. The extent of this axial movement is limited by stop member 35. Once mould part 13 has been moved to the position illustrated in FIG. 4, outer core part 17 is then axially moved until its left-hand extremity (as seen in FIGS. 3 and 4) abuts stop member 35. The position is then as illustrated in FIG. 5 and it will be seen head portion 21 of inner core part 17 has separated from head portion 23 of outer core part 19 and that groove 25 of head portion 21 of outer core part 17 is now displaced from lip 27 of socket 9. As a result, the mouth of socket 9 has become enlarged. Due to the resiliently deformable nature of the plastic of the coupling, this enlargement of the socket mouth extends from lip 27 in a gradually decreasing manner to outer mould part 11 where this mould part maintains the original diameter of the socket. Accordingly, between mould part 11 and lip 27 the socket mouth is prised outwardly.

Extending from a position just inwardly of the left-hand edge of outer mould part 11 in a direction towards lip 27, socket 9 bulges outwardly at 37 to form a recess 39. This recess will accommodate the internal seal as will be discussed below. The inner surface of the recess is defined by an enlarged annular portion 41 of head portion 23 of inner mould part 13.

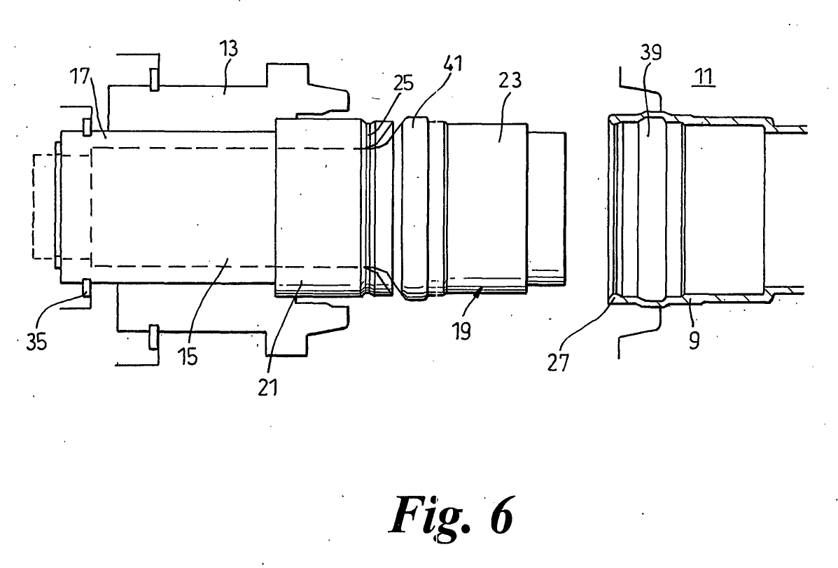

By expanding the mouth of socket 9 in the manner described above, the inner core part 19, and in particular the head portion 23 carrying enlarged portion 41, can more easily be pulled or extracted from its moulding position. FIG. 6 illustrates the position after the outer mould part 13 and inner core assembly 15 have been pulled completely away from the coupling. During the initial part of this step, that part of head portion 21 of inner mould part 11 which lies between groove 25 and the right-hand end of head portion 21 will maintain the mouth of socket 9 in its enlarged state since the lip 27 will be engaged with the outer surface of the end portion of head portion 21. This part of the pull is sufficient for the enlarged potion 41 of head portion 23 of outer mould part 13 to move out of recess 39. During subsequent extraction of the inner core assembly from the coupling, the enlarged portion 39 will move along the inner surface of the socket 9 between recess 39 and lip 27, and then past lip 27, following which the mouth of the socket, being resiliently deformable, will return to its original position while the remainder of head portion 23 of inner core part 19 is extracted from the coupling, as illustrated in FIG. 6.

Accordingly, this multi-stage core extraction or pulling procedure allows that part of the core assembly which defines the inner surface of the recess for accommodating the seal to be easily removed from the body portion of the coupling.

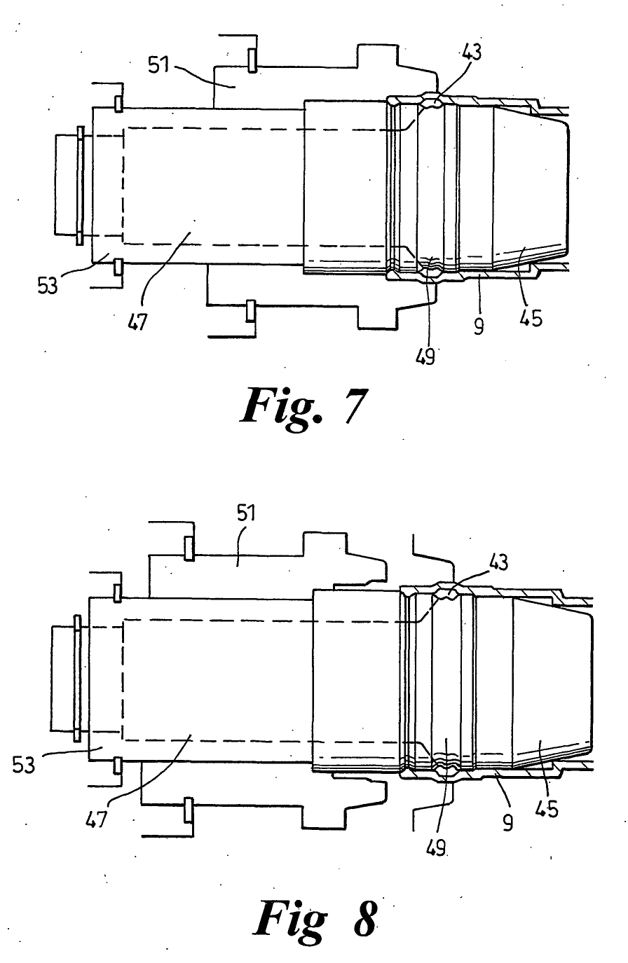

Referring now to FIG. 7 of the accompanying drawings, there is illustrated in detail the arrangement of the mould parts around one of the sockets 9 of the pipe coupling for that part of the tooling associated with the formation of the inner seal 43. Th mould parts are essentially similar to those described above in connection with a first stage of the moulding procedure. The main differences ar to the shap of head portion 45 of inner core part 47. The right-hand end of this core part slopes inwardly to the right-hand edge, the original shape (of head portion 23 not being required to form part of the mould as was previously the case). Enlarged portion 39 of head portion 23 is now replaced by a reduced diameter portion 49, the outer surface of which is shaped to provide the desired inner surface of the internal seal. Accordingly, recess 43 is defined by the outer surface of portion 49 and the inner surface of socket 9.

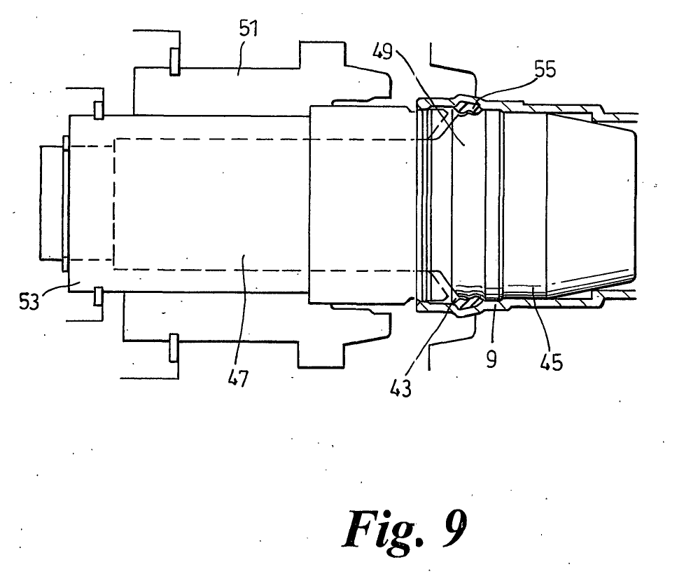

Seal material is then injected into recess 43, the procedure for which will be described in greater detail below. Once this has been effected and the seal material has been allowed to solidify, the mould parts are then separated in a manner similar to that described above after the formation of the body portion of the coupling. FIG. 8 shows the first step in this extraction procedure, namely, the removal of outer mould part 51. FIG. 9 illustrates the second step, the separation of the outer and inner core parts 53 and 47 respectively. This results in the widening of the mouth of socket 9 and enables the head portion 45 of inner core part 47 to be moved past seal 55 without dislodging it from its location within recess 43.

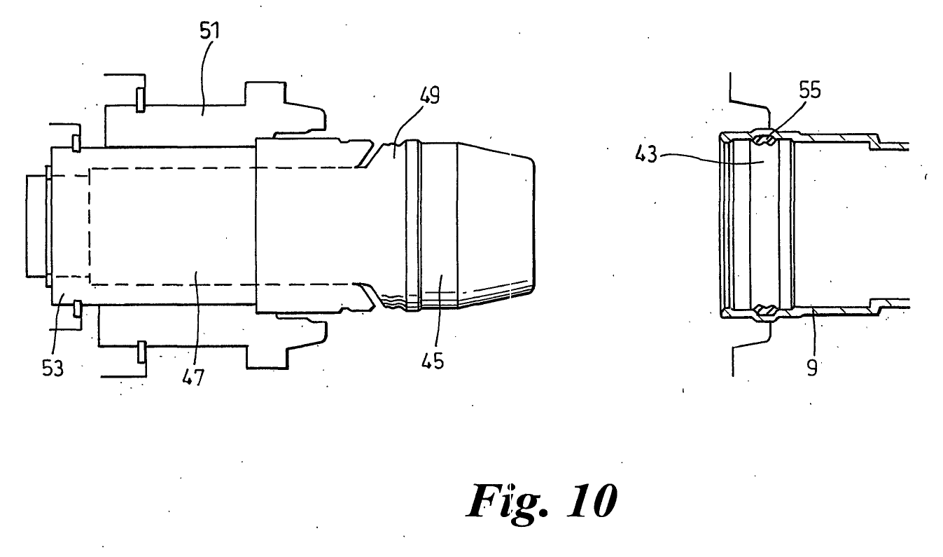

FIG. 10 illustrates the position when the inner core assembly and the outer mould part 51 have been completely removed from the coupling.

In the above-described procedure, core pulling takes place with the mould cavity closed.

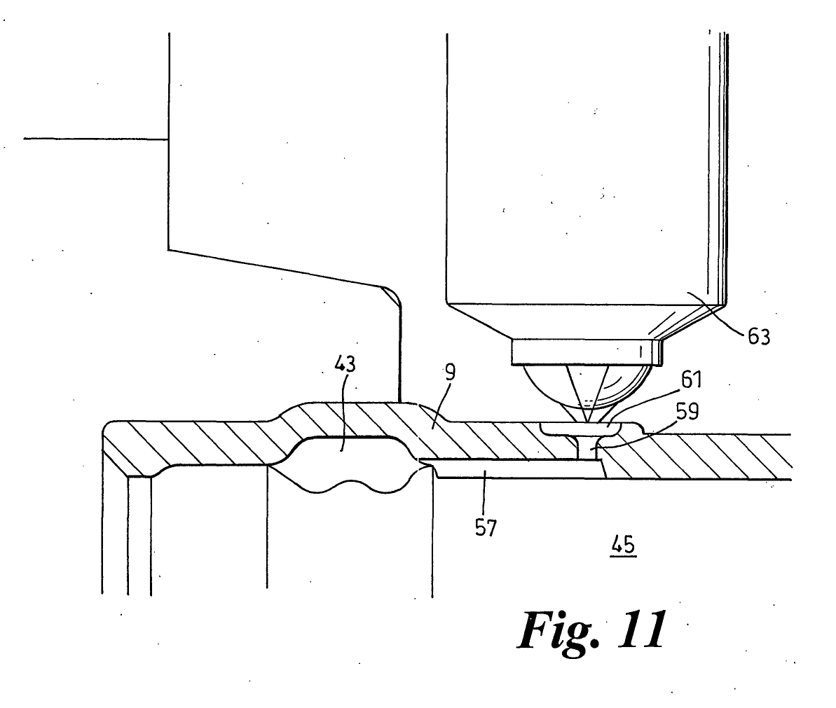

FIG. 11 illustrates in detail the injection of the seal material into recess 43. The wall of socket 9 is provided with a moulded-in channel 57 which extends from recess 43 axially along the inner surface of the socket away from its mouth. Channel 57 is defined by head portion 45 of inner core part 47 as well as the inner surface of the wall of socket 9. At the end of channel 57, the channel communicates with a radially outwardly extended hole 59 which terminates at an enlarged recess 61 on the outer surface of the wall of socket 9.

Molten seal material is introduced into recess 61 by means of an injection tool having a hot runner nozzle 63, the end of which is introduced into recess 61. Molten seal material is then forced down hole 59, along channel(s) 57 into recess 43. The seal material is then allowed to solidify so that it occupies the entire annular recess 43 as well as the channel(s) 57 and hole 59.

The material of the seal 43 can be any suitable thermoplastic elastomer.

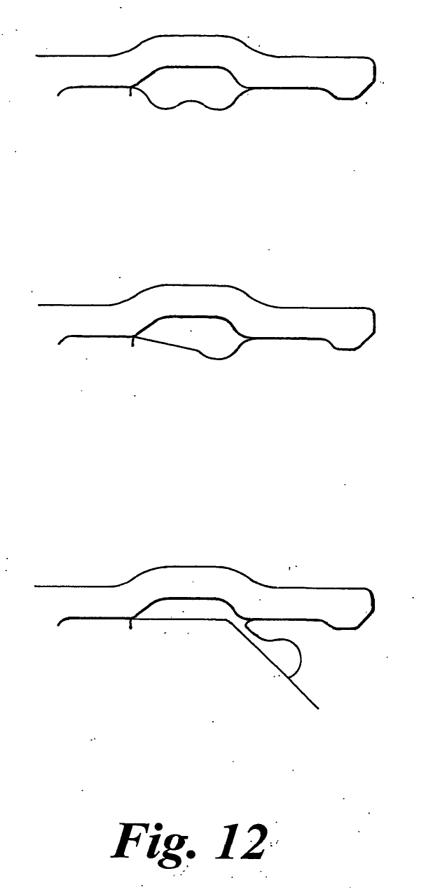

FIG. 12 of the accompanying drawings illustrates some alternative seal profile which may be made by a method, and apparatus, of the present invention.

The material of the body of the pipe coupling may be, for instance, polypropylene. The seal material may be a thermoplastic elastomer referred to as a TPE-V material in BS/EN681-2. Such a material is very flexible with a Shore hardness of about 50.

1. A method for making a pipe coupling comprising a body portion including a socket and an internal seal located within said socket and for making sealing contact with a pipe end received in the socket, said body portion and said seal being formed of plastics materials, the method comprising, in a first stage, injection moulding said body portion using a first internal core and, in a second stage, injection moulding said seal within said socket using a second internal core and by injecting material for the seal in molten form through the wall of said body portion to a space defined by said body portion and said second core, whereby, on solidifying, said second material adheres to said body portion, characterized in that said first and second internal cores each include first and second axially separable parts and said first part is provided with an external circumferential groove for accommodating an inwardly directed lip on the socket and, after each stage of injection moulding, said first part is moved axially relative to the second part causing the lip to move out of the groove thereby widening the mouth of the socket sufficiently to enable relatively unimpeded movement of said second part in a direction out of said socket.

2. Apparatus for making a pipe coupling comprising a body portion including a socket and an internal seal located within said socket for making sealing contact with a pipe end received in the socket, said body portion and said seal being formed of plastics materials, the apparatus comprising means for injection moulding said body portion using a first internal core and means for injection moulding the seal within said socket using a second internal core, said seal moulding means including means for injecting material for the seal in molten form through the wall of the body portion to a space defined by the body portion and said second core, whereby, on solidifying, said second material adheres to said body portion, characterised in that said first and second internal cores each include first and second axially separable parts and said first part is provided with an external circumferential groove for accommodating an inwardly directed lip on the socket, and means for moving said first part axially relative to the second part after each stage of injection moulding causing the lip to move out of the groove thereby widening the mouth of the socket sufficiently to enable relatively unimpeded movement of said second part in a direction out of said socket.
